(19) United States
(12) Patent Application Publication
(10) Pub. No.: US 2011/0209683 A1
(43) Pub. Date: Sep. 1, 2011

(54) METHOD OF OPERATING A SPARK IGNITION INTERNAL COMBUSTION ENGINE

(76) Inventors: Brandon M. Simmons, Seymour, IN (US); Cheng G. Li, Midland, IN (US); David F May, Columbus, IN (US)

(21) Appl. No.: 13/122,326

(22) PCT Filed: Nov. 19, 2009
(86) PCT No.: PCT/US09/65079

§ 371 Date: Apr. 1, 2011

Related U.S. Application Data
(60) Provisional application No. 61/116,326, filed on Nov. 20, 2008.

(51) Int. Cl. F02B 47/02

(52) U.S. Cl. 123/25 C

(57) ABSTRACT

A method of operating a spark ignition engine comprises introducing a fuel comprised of a water soluble organic compound and at least 30% by volume water mixed in a homogeneous charge air-fuel mixture. The air-fuel mixture is compressed in an engine having a compression ratio of at least about 16, with such compression ratios including the effective compression ratios arising from precompressing the intake air (e.g., turbocharging). The compressed air fuel mixture is then ignited by a spark or like controllable ignition source.

### FIELD OF THE INVENTION

This invention relates to a method of operating a spark ignition engine. In particular, it is a method of operating a spark ignition engine at high efficiency and low emissions with a low energy fuel.

### BACKGROUND OF THE INVENTION

Spark ignition engines, typically referred to as gasoline engines have gained popularity due to their quietness, ease of operation and controllability. Typically, spark ignition engines have utilized gasoline as a fuel, because of its low cost, wide availability and ability to be used in significantly varying ambient conditions. Gasoline engines, however, suffer from high emissions of noxious gases (e.g., NOx, CO, HC). They also tend to be less efficient. Other fuels have been used on limited bases, such as methanol or recently ethanol in open wheel race cars such as those that race at the INDIANAPOLIS 500.

These alternative fuels, however, have suffered from problems such as low specific energy content compared to gasoline (e.g., almost twice as much energy in a given volume of gasoline compared to ethanol), cost (e.g., need to distill substantial amounts of water to get to near pure alcohol), competition for feedstocks used for food (e.g., corn), still suffer from emitting noxious gases (e.g., NOx, CO and HC) and fuel variability due to their hydroscopic nature.

Accordingly, it would be desirable to provide a method of operating a spark ignition engine that is thermally efficient and produces good power while emitting reduced amounts of noxious gases and retaining the flexibility and controllability of a spark ignition engine.

### SUMMARY OF THE INVENTION

Applicants have discovered a method of operating a spark ignition engine in a manner that realizes good thermal efficiencies and power, while lowering emissions.

An aspect of the invention is a method of operating a spark ignition engine comprising,

(a) introducing an amount of a fuel comprised of a water soluble organic compound and at least 30% by volume of water into a cylinder of said engine such that a fuel air mixture is formed, and

(b) igniting the fuel-air mixture by a spark at a crank angle sufficiently advanced during the compression stroke of the spark ignition engine such that the fuel ignites and combusts, wherein the compression ratio of the engine is at least about 16.

Surprisingly, the method combining high compression ratios coupled with fuels containing substantial amounts of water allows the operation of a spark ignition engine at high thermal efficiency and power with reduced emissions such as NOx.

### BRIEF DESCRIPTION OF THE DRAWINGS

FIG. 1 shows the output of an engine run not using the method of this invention.

FIG. 2 shows the output of an engine run using the method of this invention.

### DETAILED DESCRIPTION OF THE INVENTION

In the method, the fuel introduced into the engine via the air induction system and/or directly injected into the cylinder (direct injection) is comprised of water and an organic compound that is miscible with water. To enhance the ability to form a vaporized charge, when introducing the fuel in the air induction system, such organic compounds, generally have at most about 10 carbons and desirably at most about 9, 8, 7, 6 and 5 carbons and most desirably at most about 4 carbons. Such organic compounds, to be miscible, typically will have one or more polar organic groups such as an alcohol, ether, ester, carboxylic acid, amine and the like. Exemplary organic compounds include alcohols such as methanol, ethanol, butanol, propanol, ethylene glycol and propylene glycol or mixtures thereof. In a particular embodiment, the organic compound is ethanol, methanol, propanol, butanol or mixture thereof.

The fuel comprised of water and organic compounds has a water content that is about 30% by volume of the total volume of the fuel and may be in ascending order at least about 32%, 35% or 38% to generally at most about 65%, 60%, 55% or 50%. The fuel may also contain other components useful to change a desired property such as acetylene or other hydrocarbon such as described in U.S. Pat. Nos. 2,404,094 and 4,333,739.

The fuel typically has octane ratios of at least about 110, 115, 120, 125, 130, 135, 145, or even above 150 so long as said fuel still ignites upon insertion into the cylinder of the engine and firing, for example, of the spark plug in that cylinder. Octane as used herein refers to research octane number.

The introducing of the fuel in the air induction system (e.g., intake manifold) may be accomplished by any suitable method for introducing a homogeneous charge into an air induction system such as a carburetor or injector, which may be controlled by known mechanical or electronic methods such as described on pages 430-445 in Automotive Handbook, 3^{rd} Ed., Robert Bosch GmbH, Stuttgart, Germany, 1993. Likewise, if the fuel is direct injected into the cylinder, it may be done by any suitable method such as using an injector as described below and controlled as just described above.

It is desirable for the fuel to be introduced using an injector or multiple injectors, wherein the size of the droplets of the fuel from the injector enter into the air being drawn through the intake manifold or in the cylinder are controlled and can be varied. Generally, the average diameter of the droplets by number is at most about 50, 30, 25, 20, 15, 10 or 5 micrometers in size to at least about 0.1 micrometer. It is also desirable, when introducing the fuel into the air induction system, to have the introducing of the fuel to be introduced such that it is aided by gravity to enter into the air induction system and subsequently into the cylinder of the engine (e.g., the injector is positioned on the top surface of the intake manifold, with the manifold being positioned above the cylinder).

The introducing of fuel into the air induction system, particularly, by injecting the fuel desirably occurs within about 20 cm, 15, 10 or even 5 cm to as close as practical, but generally at least a couple of cms to allow for good mixing of the fuel and air, to the intake valve of each cylinder. For example, if the engine has 6 cylinders, there would be 6 injectors mounted on the intake manifold such that each cylinder had its own injector, electronically controlled, such that it injected fuel at the desired crank angle during the intake stroke of the piston in the cylinder. Depending on whether there is one common injector or individual injectors at each cylinder of the intake manifold, the injector may be activated at differing times during the intake stroke of the piston in a cylinder.

As an illustration, when there is an injector at each cylinder, the injector for the fuel, generally, would be activated at between 90 and 0 degrees crank angle prior to the intake valve opening. Degrees of crank angle refers to the position of the piston as given by the crankshaft with regard to an event occurring such as the piston being at the top dead center “TDC” (top most) or bottom dead center “BDC” (bottom most), which is well known and depicted, for example, on page 369 of Automotive Handbook, 3^{rd} Ed., Editor in Chief: U. Adler, Robert Bosch GmbH, Stuttgart, Germany, 1993.

In an embodiment, energy or heat is provided to the fuel, prior to being injected into the air induction system. Such input of energy, may be desirable to aid in forming a homogeneous mixture/vapor with air in the air induction system. Such introduction of energy may be mechanical (e.g., ultrasonics using an electrorestrictive or magnetostrictive transduction device such as a piezoelectric transducer or a giant magnetostrictive device), or simply by heating using known methods. In a particular embodiment, the fuel is heated using the waste heat of the exhaust. In another, the fuel is heated by using a phase change material that stores the heat from the coolant system or exhaust system, which is useful upon cold start-up of the engine, because the phase change material can introduce heat to said fuel aiding in cold start up. Exemplary phase change materials that may be used include those in co-pending U.S. provisional application 61/030,755 having an inventor David Bank.

Another embodiment involves heating the induction air such that the water diluted fuel is sufficiently evaporated before induction into the combustion chamber. This induction air may be heated by a variety of means, but preferably by exchanging heat from engine coolant or exhaust heat via a heat exchanger.

In another embodiment, a start up fuel may be used to aid in cold start-up of the engine. Such start-up fuel is generally more volatile (lower heat of vaporization). For example, when the fuel is an alcohol with 40% water, the start up fuel may be a lower alcohol (e.g., ethanol, methanol, propanol, and butanol) with less than about 6% volume of water to essentially neat alcohol and, desirably, the start up fuel is an alcohol that is the same as the alcohol in the fuel (alcohol-water fuel).

After the introduction of the fuel-air mixture, the intake valve closes as is typical in a spark (gasoline) engine near bottom dead center (BDC) of the piston and the compression stroke begins as known in the art. The mixture is ignited by any suitable method and apparatus for forming a timed spark such as those known in the art. The injection of the fuel in the air induction system and subsequent combustion in the engine cylinder may utilize any suitable method (engine management), for example, such as those described on pages 438-477 in Automotive Handbook 3^{rd} Ed., Robert Bosch Gmbh, 1993. Generally, the spark occurs at a crank angle depending on the operating conditions (e.g., ambient temperature, rpm, atmospheric pressure and load) at the most efficient operation, which is readily determined on a dynamometer.

In one embodiment, it may be desirable to initiate the spark to ignite the fuel at a crank angle more advanced than an engine run in the absence of the water in the fuel with all other engine conditions being essentially the same. The fuel, generally, is ignited at a crank angle that is at least 5% more advanced, for example, than the same engine running solely with the alcohol in the fuel (e.g., alcohol-water) at the same engine conditions (e.g., rpm, load and fuel energy content) and may be at least 6%, 7%, 8%, 9%, 10%, 15%, 20%, 25%, 30%, 35%, 40%, 45% and even 50% advanced spark. For example, if the engine running with the alcohol had a timing of 20° before top dead center (TDC) of the piston at maximum brake torque, the timing of the spark of the same engine in which the fuel (corresponding water-alcohol) is introduced would typically be at least 21° before TDC for the maximum brake torque. In general, said spark timing may occur from 3° to 50° before top dead center of the piston.

The injection may be by any suitable injector or cylinder chamber shape such as those known in the art, and, for example, as described on pages 362-366 of Automotive Handbook, 3^{rd} Ed., Robert Bosch GmbH, Stuttgart, Germany, 1993.

The total air/fuel ratio, generally, is near stoichiometry (i.e., the amount, by mole of oxygen, is near that needed to oxidize the carbon and hydrogen in the fuel to CO₂ and H₂O). Generally, the air/fuel ratio by mole is at least about 0.7 to 1.3. These ratios are, generally, referred to as equivalence ratios and the equivalence ratio is, typically, at least about 0.8 or 0.9 to at most about 1.2 or 1.1.

In performing the method of the invention, to reiterate, the compression ratio is at least about 16 to generally at most about 100 (volume of the cylinder at BDC/volume of the cylinder at TDC). The effective compression ratio falls, generally, within the just mentioned ratio. Effective compression ratio merely takes into account the increase in the maximum pressure within the cylinder upon compression when the air in the air induction system is precompressed. Desirably, the compression ratio is at least about 17, 18, 19, or 20 to at most about 90, 80, 70 or 60.

In an embodiment, the air within the air induction system is precompressed (i.e., the pressure is raised compared to a naturally aspirated engine) such as by supercharging or turbocharging such as described on pages 372-375 of Automotive Handbook, 3^{rd} Ed., Robert Bosch GmbH, Stuttgart, Germany, 1993. In a particular embodiment, the precompression is carried out by a turbocharger and may be a variable geometry turbocharger.

In the embodiment where the air is compressed by a turbocharger, it has been discovered that such a turbocharger runs more efficiently than when employed in an engine not utilizing the method of this invention. This may be due to the facilitation of the extraction of useful heat by the presence of steam in the exhaust when using a compressibly nonignitable fuel having substantial amounts of water (e.g., greater than about 30% by volume). In one particular embodiment, it has been, surprisingly, found that the method of running the spark ignition engine, when using precompressed intake air (e.g., turbo or supercharged), an intercooler is not necessary to cool the heated air, realizing greater thermal efficiency and power without added mechanical complexity and energy sapping cooling. Intercooling, in previously precompressed operation of internal combustion engines, has been necessary to avoid preignition of the fuel due to the heating of already heated gas during the compression stroke of the engine.

When performing the method of the invention, it has been surprisingly found that the emissions are substantially less than the same engine run merely with the fuel without the large volume of water or compared to gasoline fueled engines. That is the NOx (nitrous oxides), HC (hydrocarbons) and particulate matter are substantially lowered. As an illustration, each individually or combined of the aforementioned noxious emissions are at most 75%, 50, 40%, 30%, 20%, 10% or even 5% of the emissions of the same engine run under the same conditions without the use of the water in the fuel in the method of this invention. Typically, the amount of HCs is essentially no HC, which is less than about 1000 ppm by volume in the exhaust. The HC may even have lower amounts of HC present in the exhaust, such as, at most about 500, 400, 300, 200, 100, 50, 25, 10 or 5 ppm by volume. Typically the amount of particulate matter in the exhaust is at most about 150, 100, 75, 50, 25, 10, 5, 1, 0.1, 0.01, or even 0.001 mg/m³ of exhaust. Typically, the amount of NOx in the exhaust is at most about 300, 250, 200, 150, 100 ppm by volume. It is understood that such amounts are directly from the engine and have not been treated in any manner such as by a catalytic converter.

Below are specific examples within the scope of the invention and comparative examples. The specific examples are for illustrative purposes only and in no way limit the invention described herein.

### EXAMPLES

### Engine Configuration A

### Compression Ratio=9.5

A gasoline passenger car engine, the GM Quad 4 having a native compression ratio of 9.5:1, is naturally aspirated, multiport fuel injected, 4 cylinders, 4 valves per cylinder and overhead cam cast iron block and aluminum head construction.

The quad 4 engine was modified to run a variety of ethanol/water fuel mixtures. All stock engine controls were removed from the engine. The engine ignition system was replaced with an AEM (Advanced Engine Management Inc. Hawthorne Calif.) engine control module (model #30-1900). This module accepted engine crank and cam positions from tone wheels machined specifically for this engine and mounted to the pulleys of the camshaft and crankshaft with the signal being provided by sensors (MODEL #MP100502, The Chemy Corporation, 10411 Corporate Drive, Pleasant Prairie, Wis.).

Additionally, said module provided pulse width modulated control of the multiport fuel injectors. Special Ford racing injectors (Ford Racing, P/N M-9593-E303 purchased from Wedan Performance, Columbus, Ind. were used in order to inject the necessary volumetric quantities of the water containing fuel. Also, the control module accepted inputs from an AEM oxygen sensor (Bosch Wideband UEGO Sensor 30-2001) located in the exhaust pipe immediately downstream of the exhaust manifold or, in the case of the turbocharged version, downstream of the turbo. Finally, the module accepted intake manifold absolute pressure (MAP) from an AEM sensor located on the intake manifold (P/N 30-2130-50).

### Comparative Example 1

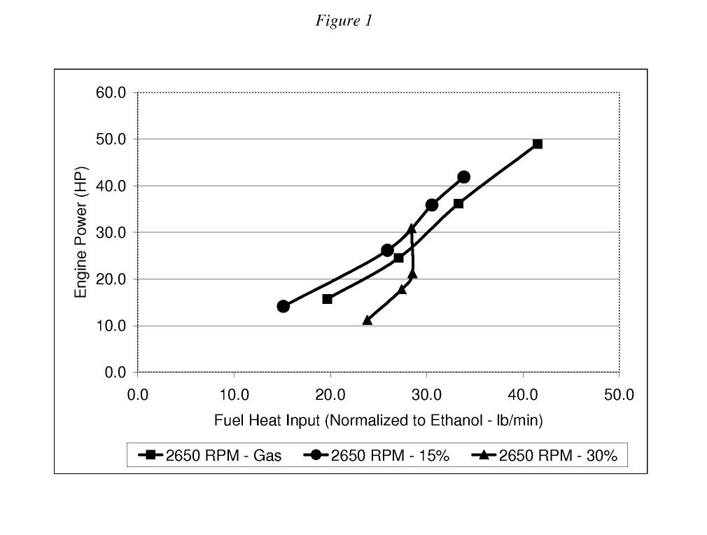

The stock engine ignition timing, air/fuel mixtures and other fundamental engine controls were used to collect baseline data using 87 octane gasolines to validate the AEM controls against a completely stock configuration. The engine performed in a like manner as the stock configuration. The engine's horsepower calculated from the maximum brake torque at 2650 rpm for a given fuel energy content (e.g., pounds/minute normalized to ethanol energy content) is shown in FIG. 1.

### Comparative Example 2

When running the engine on pure ethanol using stock timing, the engine power over most of the torque curve was comparable to the stock engine run on gasoline with the exception that additional fuel quantities had to be injected for a given torque as compared to gasoline due to the lower heat of combustion of the ethanol. The ratio of fuel injected quantity of ethanol vs. gasoline was consistent with the published heat of combustion differences of the fuels. The engine performed in a like manner as the stock configuration. The engine's horsepower calculated from the maximum brake torque at 2650 rpm for a given fuel energy content (e.g., pounds/minute normalized to ethanol energy content) is shown in FIG. 1.

### Comparative Example 3

The engine was run in the same fashion as in Comparative Examples 1 and 2 except that the fuel was varied to above 30% of water. From experiments, as the water content increases in the ethanol fuel, the engine ignition timing needed to be advanced and there was degradation in performance when the amount of water in the ethanol was about 30% by volume or above. This is shown in FIG. 1, where at about 30% of water in ethanol, the engine was sputtering and failed to make much power as shown by the bend in the curve. The engine at the lower power (fuel inputs) had to be helped by the motoring dynamometer to keep it running.

### Engine Configuration B

The Quad 4 engine of Engine Configuration A was configured with a wastegated turbocharger sized approximately for the overall flow envelope of the engine. When using the turbocharger, the oxygen sensor was located downstream of the turbo.

Using the turbocharger, when the engine is operated with substantially open or wide open throttle, the intake manifold air pressure can be raised up incrementally to approximately 35 inches (−89 cm) mercury resulting in an effective compression ratio of about 20.6:1.

### Example 1

When running this engine (Configuration B) with 40% water in ethanol fuel, with the engine boosted, for example, up to 2 atmospheres intake manifold pressure, (i.e., effective compression ratio equal to about 20.6), the engine manifested consistent, smooth combustion without misfire and with generally lower HC and CO emissions as described above than an equivalently operated gasoline engine running naturally aspirated or with equivalent ethanol or ethanol-water fuels.

### Engine Configuration C

A modified Cummins 5.9 liter ISB diesel engine was used. The engine head was modified to accept a multiport fuel injection, multi-plenum intake manifold. In this configuration, each of the 6 cylinders were fit with a Ford Racing multiport fuel injector (Ford Racing, P/N M-9593-E303 purchased from Wedan Performance, Columbus, Ind.) capable of high volumetric flow rates. The head was further modified to accept a conventional spark plug in each cylinder in the location where the diesel fuel injector was previously located. An oil seal was installed at each cylinder location to prevent engine oil from contacting the spark plug or an associated electrical wire.

In one configuration, the engine is operated without a turbocharger and in another the stock wastegated turbocharger was installed and set to gate at 35 inches (89 cm) mercury. The engine native compression ratio is 18.5:1 (i.e., without turbocharging).

The engine was adapted with the aforementioned AEM engine control module with identical ancillary measurement components and ignition systems as described for the Quad 4 (except for 6 cylinders instead of 4). A tone wheel was adapted for the crank shaft position. Cam position was obtained from a magnet machined into the cam gear inside the front engine cover. Otherwise, the base engine block, power cylinder components and head were stock.

The intake manifold was adapted with a 4 inch (10 cm) diameter throttle that is positioned by a pulse width modulated servo positioner (Holly 12R-11427 purchased from Wedan Performance, Columbus, Ind.). This throttle is continuously variable from absolute closed to wide open throttle with ¼ degree increments. A throttle position feedback provides throttle position back to the AEM module.

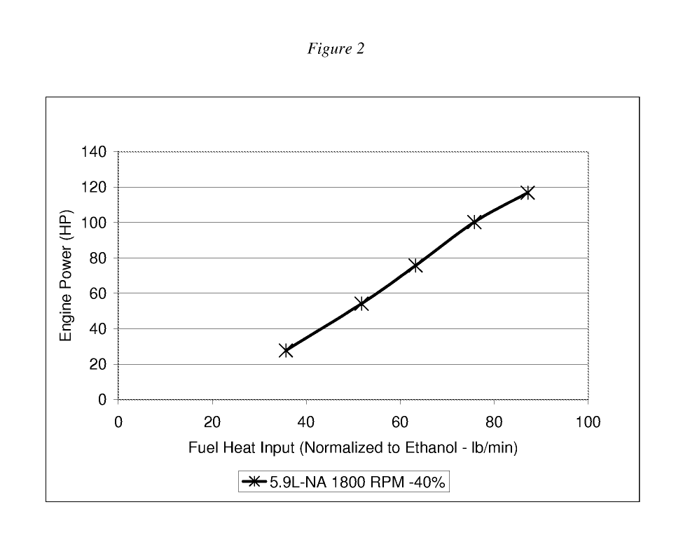

When running this engine (Configuration C) in a naturally aspirated configuration, the engine was not safely operable with less than about 10% water in ethanol due to predetonation (knock). Above this, the engine could be run with good torque compared to the engine's rating as a diesel engine as shown in FIG. 2 showing the operation at 40% water in ethanol at a fixed rpm. It was also found that the torque did not drop off at fixed energy contents above 30% water contents in the ethanol and at these higher water contents there was a substantial improvement in the emissions. In particular, the engine ran with all things being equal best for maintaining torque and low emissions at a water level of about 35% to 40% in the ethanol, even though the engine was able to run at higher water levels, the torque was degraded somewhat.

When running this engine (Configuration C) in a turbocharged configuration, the engine was not safely operable with less than 25% water in ethanol at higher rpms and loads when the manifold pressure exceeded about 20 inches of mercury due to detonation (knock). Above, this the engine could be run with good torque compared to the engine's rating as a diesel engine and it operated very similar to the same engine naturally aspirated. It was also found that the torque did not drop off at fixed energy contents above 30% water contents in the ethanol and at these higher water contents there was a substantial improvement in the emissions even compared to the same engine operated under natural aspiration (compression ratio of about 18.5 to 1), when the pressure in the manifold exceeded atmospheric pressure. In particular, the engine ran with all things being equal best for maintaining torque and low emissions at a water level of about 35% to 40% in the ethanol, even though the engine was able to run at higher water levels, the torque was degraded somewhat.

What is claimed is:

1. A method of operating a spark ignition engine comprising,
(a) introducing an amount of a fuel comprised of a water soluble organic compound and at least 30% by volume of water into a cylinder of said engine such that a fuel air mixture is formed, and
(b) igniting the fuel-air mixture by a spark at a crank angle sufficiently advanced during the compression stroke of the spark ignition engine such that the fuel ignites and combusts, wherein the compression ratio of the engine is at least about 16.

2. The method of claim 1, wherein the fuel has an octane rating of at least about 110 to at most about 250.

3. The method of claim 2, wherein the fuel has an octane rating of at least about 130.

4. The method of claim 1, wherein the water soluble organic compound has at most about 10 carbons.

5. The method of claim 4, wherein the water soluble organic compound has at most about 6 carbons.

6. The method of claim 1, wherein the water soluble organic compound has an alcohol, ether, ketone, carboxylic acid group or combination thereof.

7. The method of claim 6, wherein the water soluble organic compound is an alcohol.

8. The method of claim 7, wherein the alcohol is methanol, ethanol, propanol, butanol or mixture thereof.

9. The method of claim 8, wherein the alcohol is methanol, ethanol or combination thereof.

10. The method of claim 1, wherein the amount of water is at least about 32% to at most about 60% by volume.

11. The method of claim 10, wherein the amount of water is at least about 35%.

12. The method of claim 1, wherein the fuel is heated or energy added thereto prior or during said fuel being introduced into said cylinder.

13. The method of claim 1, wherein the fuel is introduced by injecting a liquid spray into the air induction system.

14. The method of claim 13, wherein the injecting creates spray droplets having an average droplet size of at most about 25 micrometers in diameter.

15. The method of claim 14, wherein the injecting is performed such that gravity assists in the introduction of the fuel-air mixture into the cylinder of said engine.

16. The method claim 15, wherein the injecting is performed within 10 cm of an intake valve for the cylinder.

17. The method of claim 1, wherein said engine has a plurality of cylinders and the fuel is introduced by injecting a liquid spray into the air induction system within 5 cm of an intake valve for each cylinder.

18. The method of claim 1, wherein after combustion, there is essentially no hydrocarbons present after combustion in the exhaust.

19. The method of claim 18, wherein the amount of hydrocarbons is at most about 500 ppm by volume in the exhaust.

20. The method of claim 1, wherein the compression ratio is at least about 18 to at most about 30.

21. The method of claim 1, wherein the air in the air induction system is raised to a pressure above ambient pressure.

22. The method of claim 21, wherein the pressure is raised by a turbocharger.

23. The method of claim 12, wherein at least a portion of the energy added to the fuel is from waste heat from the engine.

24. The method of claim 23, wherein at least a portion of the energy added is from a phase change material that has captured a portion of the waste heat of the engine.

25. The method of claim 21, wherein the air in the induction system is not cooled other than by the fuel introduced into the air induction system.

26. The method of claim 1, wherein the fuel is injected directly into the cylinder.

27. The method of claim 1, wherein the fuel is introduced into cylinder by injecting the fuel into the engine's air induction system such that a homogeneous fuel-air mixture is formed, which is then introduced into said cylinder of said engine.
